(19) United States
(12) Patent Application Publication
(10) Pub. No.: US 2020/0203026 A1
(43) Pub. Date: Jun. 25, 2020

(54) SYSTEM OF INDUSTRIAL INTERNET OF THINGS AND INFORMATION PROCESSING DEVICE THEREOF

(71) Applicant: TANGRAM CO., Ltd., Taichung City (TW)

(72) Inventors: Shih-Ying HUANG, Taichung City (TW); Ting-Hao LIN, Taichung City (TW)

(73) Assignee: TANGRAM CO., Ltd., Taichung City (TW)

(21) Appl. No.: 16/709,003

(22) Filed: Dec. 10, 2019

(30) Foreign Application Priority Data
Dec. 22, 2018 (TW) 107146670

(51) Int. Cl. G16Y 40/35; G16Y 30/00; G16Y 40/10; G06N 5/02; G06F 17/11; H04W 84/18; H04W 4/80

(52) U.S. Cl. CPC G16Y 40/35; G16Y 30/00; G16Y 40/10; H04W 4/80; G06F 17/11; H04W 84/18; G06N 5/025

(57) ABSTRACT

An information processing device includes a communication module, a storage storing an entry of identification data and an enforced computation rule set, and a processor connected to the aforementioned components. The entry of identification data contains component information and component-status information. The processor generates a current instance of the component-status information according to the enforced computation rule set, writes the current instance of the component-status information into the entry of identification data for updating the component-status information, makes the entry of identification data serve as a network name, and broadcasts the network name.

### CROSS-REFERENCE TO RELATED APPLICATION

This application claims priority of Taiwanese Invention Patent Application No. 107146670, filed on Dec. 22, 2018.

### FIELD

The disclosure relates to data collection, and more particularly to a system of Industrial Internet of Things (IIoT) and an information processing device thereof.

### BACKGROUND

Conventionally, a machine controller is utilized to obtain operation information related to a whole machine, which often lack detailed information of individual components on the machine. Therefore, information related to vibrations of a spindle, backlash of a screw rod, or pressure of refrigerant are not available, which is a disadvantage in dealing with issues such as maintenance and troubleshooting of the machine.

Additionally, obtaining detailed operation information related to individual components on a machine is essential to implementing production line automation or smart factory in realizing Industry 4.0 or Industrial Internet of Things (IIoT).

### SUMMARY

Therefore, an object of the disclosure is to provide a system of Industrial Internet of Things (IIoT) and an information processing device thereof that can alleviate at least one of the drawbacks of the prior art.

According one aspect of the disclosure, the system of IIOT is adapted to collect operation information related to a component of a machine. The system includes a user terminal and an information processing device disposed on the component. The information processing device is communicable with the user terminal according to a wireless communication protocol, and corresponds to a network name that is related to the wireless communication protocol. The information processing device is configured to store an entry of identification data and an enforced computation rule set that corresponds to the component. The entry of identification data contains component information that corresponds to the component and component-status information that indicates an operating status of the component. The information processing device is further configured to generate a current instance of the component-status information according to the enforced computation rule set, to write the current instance of the component-status information into the entry of identification data for update of the component-status information, to make the entry of identification data serve as the network name, and to broadcast the network name. The user terminal is configured to, when in receipt of the network name from the information processing device, present the operating status of the component based on the network name thus received.

According to another aspect of the disclosure, the information processing device is adapted to collect operation information related to a component of a machine. The information processing device is to be disposed on the component, and corresponds to a network name. The information processing device includes a communication module, a storage and a processor. The communication module supports a wireless communication protocol. The network name is related to the wireless communication protocol. The storage is configured to store an entry of identification data and an enforced computation rule set that corresponds to the component. The entry of identification data contains component information that corresponds to the component and component-status information that indicates an operating status of the component. The processor is electrically connected to the communication module and the storage. The processor is configured to generate a current instance of the component-status information according to the enforced computation rule set stored in the storage, to write the current instance of the component-status information into the entry of identification data for update of the component-status information, to make the entry of identification data stored in the storage serve as the network name, and to broadcast the network name.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating an embodiment of a system of Industrial Internet of Things (IIoT) according to the disclosure;

FIG. 2 is a flow chart illustrating a flow of a procedure of collecting operation information related to a component of a machine by the system according to the disclosure; and

FIG. 3 is a schematic diagram illustrating a user interface of a user terminal of the system according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

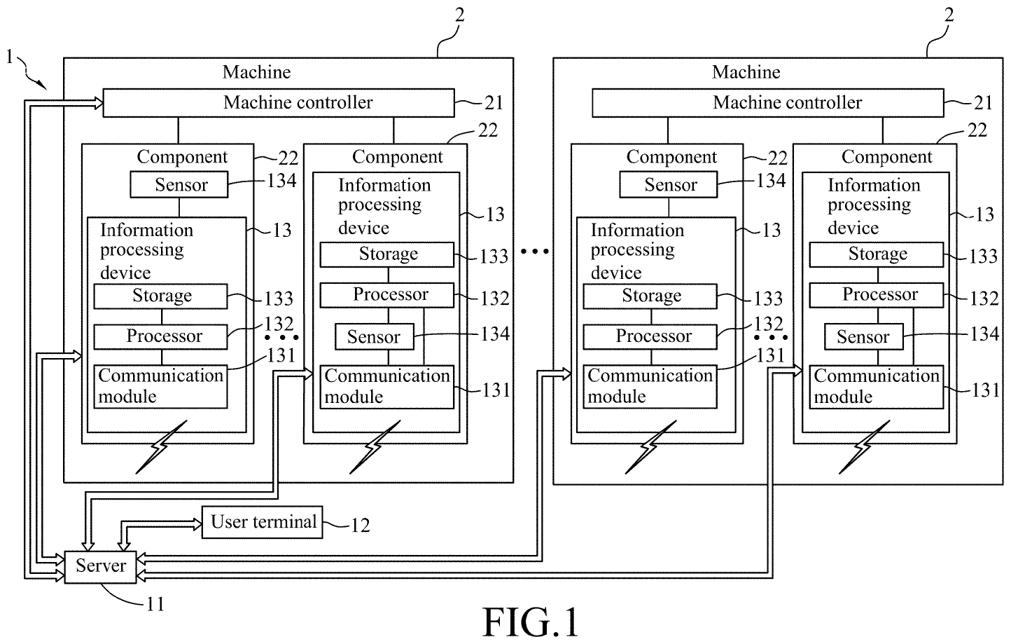

Referring to FIG. 1, an embodiment of a system 1 of Industrial Internet of Things (IIoT) is illustrated. The system 1 is adapted to collect operation information related to a component 22 of a machine 2.

The machine 2 includes a machine controller 21 and a plurality of components 22 electrically connected to the machine controller 21. It should be noted that in this embodiment, the components 22 and the machine 2 are both plural in number as shown in FIG. 1. However, only one machine 2 will be used for explanation herein for the sake of brevity and clarity. In this embodiment, the machine 2 is a machine tool. The machine controller 21 has network communication ability and controls the components 22. Each of the components 22 may be a spindle, a fourth/fifth axis, a cooler, an oil hydraulic press, a tool magazine, a pump, or a chip conveyor. However, implementations of the machine 2, the machine controller 21 and the components 22 are not limited to the disclosure herein and may vary in other embodiments. In some embodiments, the machine 2 may include only one component 22.

The system 1 includes a server 11, a user terminal 12 and a plurality of information processing devices 13.

The server 11 is communicable with the user terminal 12 and the information processing devices 13, and is configured to store a plurality of reference computation rule sets. The server 11 may be implemented to be a computing server or a data server, but implementation of the server 11 is not limited to the disclosure herein and may vary in other embodiments.

The user terminal 12 is a mobile device such as a smartphone or a laptop computer, but implementation of the user terminal 12 is not limited to the disclosure herein and may vary in other embodiments.

Each of the information processing devices 13 is to be disposed on one of the components 22 of the machine 2, and is communicable with the user terminal 12 according to a wireless communication protocol. Each of the information processing devices 13 corresponds to a network name that is related to the wireless communication protocol. Each of the information processing devices 13 is configured to store in advance an entry of identification data and an enforced computation rule set that corresponds to said one of the components 22 on which the information processing device 13 is disposed. The entry of identification data contains component information that corresponds to said one of the components 22 and component-status information that indicates an operating status of said one of the components 22. The enforced computation rule set may contain plural computation rules. In this embodiment, the component information may include information related to a manufacturer of said one of the components 22 (e.g., a name of the manufacturer, fundamental information of the manufacturer, or languages supported by the manufacturer), information related to identification of a product (e.g., a product name, a category of the product, description of the product, or a product version), and a production serial number of said one of the components 22. However, implementation of the component information is not limited to the disclosure herein and may vary in other embodiments.

Specifically speaking, each of the information processing devices 13 includes a communication module 131 supporting the wireless communication protocol, a storage 133 configured to store the entry of identification data and the enforced computation rule set, and a processor 132 electrically connected to the communication module 131 and the storage 133. In this embodiment, each of the information processing devices 13 is an integrated single-chip capable of carrying out the operations described in this disclosure, but implementation of the information processing devices 13 is not limited to the disclosure herein and may vary in other embodiments. For example, the communication module 131 may be a wireless transceiver, the storage 133 may be a non-volatile memory, the processor 132 may be a microprocessor or a microcontroller, and the communication module 131, the storage 133 and the processor 132 are disposed on and connected together through a printed circuit board to constitute the information processing device 13.

The communication module 131 utilizes the wireless communication protocol to communicate with the server 11 and the user terminal 12. In one embodiment, the wireless communication protocol follows the standards of Wireless Fidelity (Wi-Fi), and the network name corresponding to the information processing device 13 is a Service Set Identifier (SSID). In one embodiment, the wireless communication protocol follows the standards of Bluetooth technology, and the network name corresponding to the information processing device 13 is a Bluetooth device name.

Before one of the information processing devices 13 is used (i.e., to be disposed on one of the components 22) for the first time, a corresponding entry of identification data and an enforced computation rule set that corresponds to said one of the components 22 are written in the storage 133 of said one of the information processing devices 13 first. After establishing communication with the server 11, the processor 132 determines whether a version of said one of the information processing devices 13 matches a latest version number recorded by the server 11. When a result of the aforementioned determination is negative, the processor 132 determines that the enforced computation rule set stored in the storage 133 needs to be updated. However, the process of check for an update is not limited to the disclosure herein and may vary in other embodiments. In some embodiments, the server 11 actively broadcasts update messages to notify the information processing devices 13 to update the respective enforced computation rule sets stored therein. The processor 132 of said one of the information processing devices is configured to, when it is determined thereby that the enforced computation rule set stored in the storage 133 needs to be updated, transmit a data request that contains the component information corresponding to said one of the components 22 via the communication module 131 to the server 11. The server 11 is configured to, when the server 11 is in receipt of the data request, determine one of the reference computation rule sets to serve as a target computation rule set based on the component information contained in the data request, and to transmit the target computation rule set to said one of the information processing devices 13. Said one of the information processing devices 13 is configured to, upon receipt of the target computation rule set transmitted by the server 11, store the target computation rule set to serve as the enforced computation rule set (i.e., the target computation rule set replaces the previous enforced computation rule set stored in the storage 133).

Each of the information processing devices 13 further includes a sensor 134. The sensor 134 may be implemented to be integrated in said each of the information processing devices 13 to serve as a build-in sensor, or may be implemented to be an external sensor that is to be disposed on the component 22. The sensor 134 is configured to detect an operational property of the component 22 so as to generate a detection signal. The operational property may include temperature of the component 22, pressure of the component 22, a vibration of the component 22 or an electric current flowing into/outputted by the component 22. However, implementation of the operational property is not limited to the disclosure herein and may vary in other embodiments. In other embodiments, the sensor may be part of the machine 2.

For example, the server 11 establishes a database (not shown) in advance, and stores plural entries of component information, and the reference computation rule sets that are respectively related to the entries of component information in the database. The server 11 determines the component information contained in the data request, and determines one of the reference computation rule sets that corresponds to the component information contained in the data request to serve as the target computation rule set. In a scenario that the component 22 is a spindle (not shown) and one of the information processing devices 13 is disposed thereon, the component information corresponding to the spindle includes information related to a manufacturer of the spindle, information related to a product identification of the spindle, and a production serial number of the spindle. The information related to the manufacturer of the spindle, the information related to the product identification of the spindle, and the production serial number of the spindle cooperatively indicate types of sensors that are necessary to detect the operational properties of the spindle (e.g., a vibration sensor, a thermometer, an ammeter, which are not shown, or the like), and indicate the target computation rule set that is required to generate the component-status information of the spindle. When in receipt of the data request, the server 11 parses the component information contained in the data request so as to obtain the information related to the manufacturer of the spindle, the information related to the product identification of the spindle, and the production serial number of the spindle. Next, based on the information related to the manufacturer of the spindle, the information related to the product identification of the spindle, and the production serial number of the spindle thus obtained, the server 11 determines one of the reference computation rule sets in the database of the server 11 to serve as the target computation rule set for generating a current instance of the component-status information of the spindle. Later, the server 11 transmits the target computation rule set to said one of the information processing devices 13 so as to enable said one of the information processing devices 13 to store the target computation rule set to serve as the enforced computation rule set.

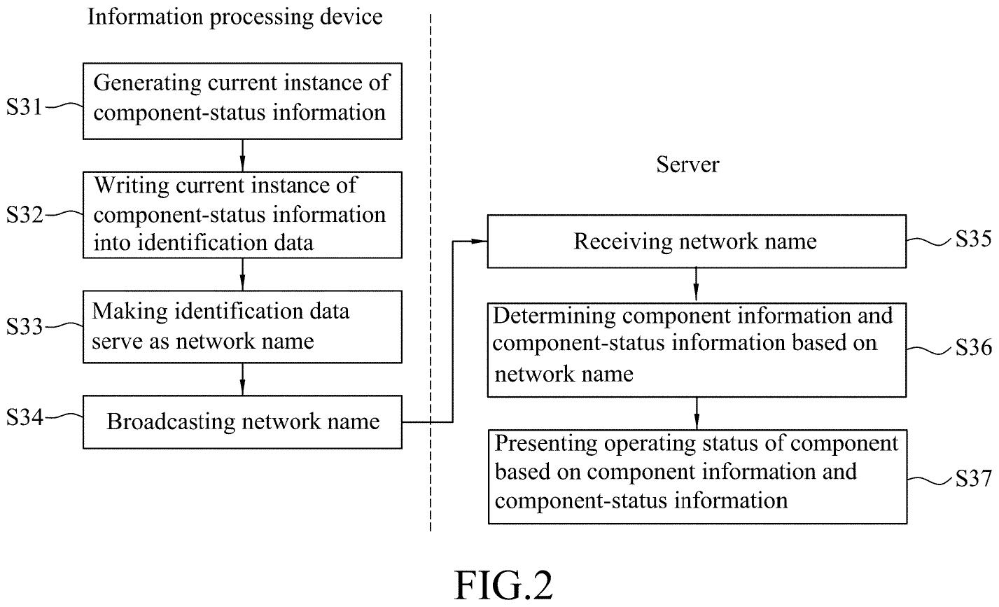

FIGS. 1, 2 and 3 illustrate a flow of a procedure for collecting operation information related to the component 22 by one of the information processing devices 13 of the system 1 disposed thereon according to the disclosure. The flow includes step S31 to S37 described as follows.

In step S31, according to the enforced computation rule set stored in the storage 133 of said one of the information processing devices 13, the processor 132 of said one of the information processing devices 13 generates a current instance of the component-status information of the component 22 on which said one of the information processing devices 13 is disposed. Specifically speaking, the processor 132 is configured to obtain the detection signal generated by the sensor 134 of said one of the information processing devices 13, and to generate the current instance of the component-status information based on the detection signal and the enforced computation rule set stored in the storage 133. In one embodiment, the processor 132 is configured to first generate a computation result based on the detection signal and the enforced computation rule set stored in the storage 133, and then to generate the current instance of the component-status information based on the computation result and the enforced computation rule set stored in the storage 133.

Following the previous example where the component 22 is the spindle, the enforced computation rule set stored in the storage 133 may be exemplified to include computation rules like “when a temperature of the spindle detected by the thermometer (i.e., the detection signal generated by the sensor 134) is greater than a threshold value of the temperature, generating the component-status information indicating that the temperature of the spindle is abnormal; otherwise, generating the component-status information indicating that the temperature of the spindle is normal”, or “performing fast Fourier transform (FFT) on an entry of time-domain data outputted by the vibration sensor to obtain the computation result; determining whether a value of the computation result falls in a predetermined range; when it is determined that the value of the computation result falls in the predetermined range, generating the component-status information indicating that the vibration of the spindle is normal; otherwise, generating the component-status information indicating that the vibration of the spindle is abnormal”, and so on. However, it should be noted that implementation of the computation rule set is not limited to the disclosure herein and may vary in other embodiments.

It is worth to note that in one embodiment, the processor 132 may generate the current instance of the component-status information of the component 22 based solely on the enforced computation rule set stored in the storage 133. For example, in a scenario that a specific component 22 needs regular maintenance whenever it is used for a predetermined time period, the information processing device 13 disposed on the specific component 22 may count an accumulated operating time period of the specific component 22, and the enforced computation rule set stored in the storage 133 may include a computation rule such as “when the accumulated operating time period is longer than the predetermined time period, generating the component-status information indicating that the specific component 22 needs the regular maintenance”.

In step S32, the processor 132 of said one of the information processing devices 13 writes the current instance of the component-status information generated in step S31 into the entry of identification data stored in the storage 133 for update of the component-status information of the entry of identification data.

In step S33, the processor 132 of said one of the information processing devices 13 designates the network name as the entry of identification data thus updated (i.e., makes the entry of identification data thus updated serve as the network name). Specifically speaking, the processor 132 uses the entry of identification data thus updated to serve as the SSID when the wireless communication protocol supported by the communication module 131 follows the standards of Wi-Fi, and uses the entry of identification data thus updated as the Bluetooth device name when the wireless communication protocol supported by the communication module 131 follows the standards of Bluetooth technology.

In step S34, the processor 132 of said one of the information processing devices 13 broadcasts the network name designated in step S33 via the communication module 131.

In step S35, the user terminal 12 that is on the same communication network with said one of the information processing devices 13 is configured to receive the network name broadcasted by said one of the information processing devices 13 through scanning the communication network.

In step S36, the user terminal 12 is configured to parse the network name received in step S35, so as to determine the component information and the component-status information.

In step S37, the user terminal 12 is configured to present (e.g., provide a visual presentation) the operating status of the component 22 based on the component information and the component-status information determined in step S36.

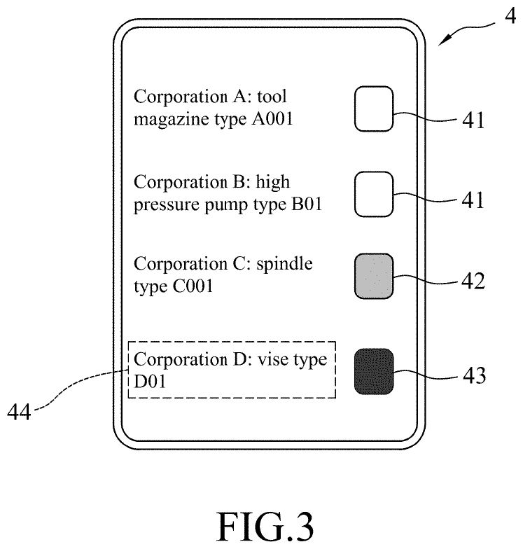

In this embodiment, an application program is installed in the user terminal 12, and the user terminal 12 is configured to execute the application program to perform steps S35 to S37 that are previously mentioned and to display a user interface 4 as shown in FIG. 3. For example, the user terminal 12 executes the application program to receive four network names after scanning the communication network, and then the user terminal 12 determines four entries of data each being a combination of the component information and the component-status information by respectively parsing the four network names thus received. The four entries of data respectively correspond to operating statuses of four types of the components 22: “Corporation A: tool magazine type A001—normal”, “Corporation B: high pressure pump type B01-normal”, “Corporation C: spindle type C001—warning”, and “Corporation D: vise type D01—prohibited”. The application program may be programmed to utilize different colored blocks to represent respective kinds of operating statuses of the component 22. Referring to the example shown in FIG. 3, a first colored block 41 indicates that the operating status is “normal”; a second colored block 42 indicates that the operating status is “warning”; and a third colored block 43 indicates that the operating status is “prohibited”.

It should be noted that in practice, the user terminal 12 of the system 1 may be plural in number, and none of the user terminals 12 has to establish a one-to-one data communication with a specific one of the information processing devices 13 in order to procure the operating status of the component 22 on which said specific one of the information processing devices 13 is disposed. That is to say, by receiving the network name broadcasted by the specific one of the information processing devices 13 through scanning the communication network, said one of the user terminals 12 is capable of obtaining, based on the network name thus received, the operating status of the component 22 on which said specific one of the information processing devices 13 is disposed. Therefore, each one of the user terminals 12 is capable of obtaining a plurality of the operating statuses of the components 22 that are located within the same communication network at the same time, realizing many-to-many communication and enhancing efficiency and convenience in data collection.

After seeing the operating statuses of the components 22 via the user interface 4, a user is able to obtain further detailed information of the operating status of one of the components 22 via the user interface 4. For example, as shown in FIG. 3, after seeing “Corporation D: vise type D01—prohibited”, the user may want to obtain further detailed information of the operating status of the vise type D01. To do so, the user operates the user interface 4 by using a mouse to click on or by touch input to select a region 44 on the user interface 4 where the operating status of the vise type D01 is presented so as to enable the information processing device 13 that is disposed on the vise type D01 to establish a one-to-one data communication with the user terminal 12 of the user.

Subsequently, the processor 132 of this information processing device 13 is configured to transmit a data set containing detailed information of the vise type D01 via the communication module 131 to the user terminal 12 so as to enable the user terminal 12 to present the data set, wherein the data set contains at least one of the detection signal, the component-status information and the computation result that relate to the vise type D01. In other words, the data set contains one of the detection signal, the component-status information, the computation result, and any combination thereof. As a result, the user may know why the vise type D01 is prohibited. It should be noted that implementation of the data set is not limited to the disclosure herein and may vary in other embodiments.

It should be noted that the user terminal 12 is configured to, when in receipt of the data set transmitted by one of the information processing devices 13, transmit the data set to the server 11. In this embodiment, each of the information processing devices 13 is capable of transmitting the data set directly to the server 11. In one embodiment, one of the information processing devices 13 is configured to transmit the data set to the machine controller 21, and then the machine controller 21 relays the data set thus received to the server 11. In this way, the server 11 is capable of collecting the operation information (e.g., the detection signal, the component-status information and/or the computation result) related to each of the components 22, facilitating failure prediction and troubleshooting in a manufacturing process involving use of the machine 2. Moreover, the operation information thus collected may be processed by big data analysis, and be applied to implementation of the production line automation or the smart factory.

In summary, the system 1 of IIoT according to the disclosure generates the current instance of the component-status information corresponding to one of the components 22 of the machine 2 based on a corresponding one of the enforced computation rule sets, writes the current instance of the component-status information into the entry of identification data for updating the component-status information, makes the entry of identification data serve as the network name corresponding to the information processing device 13 that is disposed on said one of the components 22, and broadcasts the network name on the communication network. Consequently, for each of the components 22, any user terminal 12 on the communication network is capable of obtaining the network name corresponding to the information processing device 13 disposed on the component 22 by scanning the communication network, so as to gather status information related to operation of the component 22 based on the network name, enabling concurrent many-to-many communication and enhancing efficiency and convenience of information gathering. Moreover, a user is able to check, at any time, the operation status of any one of the components 22 on which the information processing device 13 is disposed, so the user may be able to efficiently distinguish which one of the components 22 malfunctions whenever an abnormal condition occurs on the machine 2, saving time and manpower. Furthermore, the status information related to the components 22 thus gathered can be utilized by the server 11 for further data processing and data analysis.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A system of Industrial Internet of Things (IIoT), adapted to collect operation information related to a component of a machine, said system comprising:
a user terminal; and
an information processing device disposed on the component, communicable with said user terminal according to a wireless communication protocol, corresponding to a network name that is related to the wireless communication protocol, and configured to store an entry of identification data and an enforced computation rule set that corresponds to the component, the entry of identification data containing component information that corresponds to the component and component-status information that indicates an operating status of the component,
wherein said information processing device is further configured to generate a current instance of the component-status information according to the enforced computation rule set, to write the current instance of the component-status information into the entry of identification data for updating the component-status information, to make the entry of identification data serve as the network name, and to broadcast the network name, and
wherein said user terminal is configured to, when in receipt of the network name from said information processing device, present the operating status of the component based on the network name thus received.

2. The system as claimed in claim 1, the machine further including a sensor disposed on the component, the sensor detecting an operational property of the component so as to generate a detection signal, wherein:
said information processing device is configured to obtain the detection signal generated by the sensor, and to generate the current instance of the component-status information based on the enforced computation rule set and the detection signal.

3. The system as claimed in claim 2, wherein said information processing device is further configured to generate a computation result based on the enforced computation rule set and the detection signal.

4. The system as claimed in claim 3, further comprising:
a server communicable with said user terminal,
wherein said information processing device is further configured to, when said user terminal has established a one-to-one data communication with said information processing device, transmit a data set that contains at least one of the detection signal, the component-status information and the computation result to said user terminal, and
wherein said user terminal is configured to, when in receipt of the data set transmitted by said information processing device, transmit the data set to said server.

5. The system as claimed in claim 3, further comprising:
a server communicable with said information processing device,
wherein said information processing device is further configured to transmit a data set that contains at least one of the detection signal, the component-status information and the computation result to said server.

6. The system as claimed in claim 1, wherein:
said information processing device further includes a sensor that is configured to detect an operational property of the component so as to generate a detection signal, and is configured to generate the current instance of the component-status information based on the enforced computation rule set and the detection signal.

7. The system as claimed in claim 6, wherein said information processing device is further configured to generate a computation result based on the enforced computation rule set and the detection signal.

8. The system as claimed in claim 7, further comprising:
a server communicable with said user terminal,
wherein said information processing device is further configured to, when said user terminal has established a one-to-one data communication with said information processing device, transmit a data set that contains at least one of the detection signal, the component-status information and the computation result to said user terminal, and
wherein said user terminal is configured to, when in receipt of the data set transmitted by said information processing device, transmit the data set to said server.

9. The system as claimed in claim 7, further comprising:
a server communicable with said information processing device,
wherein said information processing device is further configured to transmit a data set that contains at least one of the detection signal, the component-status information and the computation result to said server.

10. The system as claimed in claim 1, further comprising:
a server communicable with said information processing device, and configured to store a plurality of reference computation rule sets,
wherein said information processing device is configured to transmit a data request that contains the component information corresponding to the component to said server,
wherein said server is configured to, when in receipt of the data request, determine one of the reference computation rule sets to serve as a target computation rule set based on the component information contained in the data request, and to transmit the target computation rule set to said information processing device, and
wherein said information processing device is configured to, when in receipt of the target computation rule set transmitted by said server, store the target computation rule set to serve as the enforced computation rule set.

11. The system as claimed in claim 1, wherein:
the wireless communication protocol follows the standards of Wireless Fidelity (Wi-Fi); and
the network name corresponding to said information processing device is a Service Set Identifier (SSID).

12. The system as claimed in claim 1, wherein:
the wireless communication protocol follows the standards of Bluetooth technology; and
the network name corresponding to said information processing device is a Bluetooth device name.

13. An information processing device adapted to collect operation information related to a component of a machine, said information processing device to be disposed on the component, corresponding to a network name, and comprising:
a communication module supporting a wireless communication protocol, the network name being related to the wireless communication protocol;
a storage configured to store an entry of identification data and an enforced computation rule set that corresponds to the component, the entry of identification data containing component information that corresponds to the component and component-status information that indicates an operating status of the component; and
a processor electrically connected to said communication module and said storage, and configured to generate a current instance of the component-status information according to the enforced computation rule set stored in said storage, to write the current instance of the component-status information into the entry of identification data for updating the component-status information, to make the entry of identification data stored in said storage serve as the network name, and to broadcast the network name.

14. The information processing device as claimed in claim 13, the machine further including a sensor disposed on the component, the sensor detecting an operational property of the component so as to generate a detection signal, wherein:
said processor is further configured to obtain the detection signal generated by the sensor, and to generate the current instance of the component-status information based on the enforced computation rule set and the detection signal.

15. The information processing device as claimed in claim 14, wherein said processor is further configured to generate a computation result based on the enforced computation rule set and the detection signal.

16. The information processing device as claimed in claim 15, being communicable with a server, wherein said processor is further configured to transmit, via said communication module, a data set that contains at least one of the detection signal, the component-status information and the computation result to the server.

17. The information processing device as claimed in claim 13, further comprising a sensor that is configured to detect an operational property of the component so as to generate a detection signal, and to generate the current instance of the component-status information based on the enforced computation rule set and the detection signal.

18. The information processing device as claimed in claim 17, wherein said processor is further configured to generate a computation result based on the enforced computation rule set and the detection signal.

19. The information processing device as claimed in claim 18, being communicable with a server, wherein said processor is further configured to transmit a data set that contains at least one of the detection signal, the component-status information and the computation result to the server.

20. The information processing device as claimed in claim 13, being communicable with a server, the server storing a plurality of reference computation rule sets and determining one of the reference computation rule sets to serve as a target computation rule set based on a data request, wherein:
said processor is configured to, when in receipt of the target computation rule set transmitted by said server, store the target computation rule set in said storage to serve as the enforced computation rule set.

21. The information processing device as claimed in claim 13, wherein:
the wireless communication protocol supported by said communication module follows the standards of Wireless Fidelity (Wi-Fi); and
the network name corresponding to said information processing device is a Service Set Identifier (SSID).

22. The system as claimed in claim 13, wherein:
the wireless communication protocol supported by said communication module follows the standards of Bluetooth technology; and
the network name corresponding to said information processing device is a Bluetooth device name.
